(19) United States
(12) Patent Application Publication
(10) Pub. No.: US 2015/0083353 A1
(43) Pub. Date: Mar. 26, 2015

(54) Electrical Insulating Paper

(71) Applicant: PACON LTD. & CO. KG, Munich (DE)

(72) Inventors: Tobias A. Kleemann, Seeshaupt (DE); Angelika Kleemann, Seeshaupt (DE)

(21) Appl. No.: 14/396,834

(22) PCT Filed: Apr. 29, 2013
(86) PCT No.: PCT/EP2013/058910

§ 371 Date: Oct. 24, 2014

(30) Foreign Application Priority Data
Apr. 27, 2012 (DE) 102012103775.2

(51) Int. Cl. H01B 3/52; D21H 21/20; D21H 17/55; D21H 11/04

(52) U.S. Cl. CPC H01B 3/52; D21H 11/04; D21H 21/20; D21H 17/55
USPC 162/138

(57) ABSTRACT

An electrical insulating paper, and methods of making and using same, having a dielectric strength of greater than 40 kV/mm, including 20% to 99% by weight of cellulose and 1% to 80% by weight of mineral fillers.

The invention concerns an electrical insulation paper that can be manufactured in a simple and cost-effective manner, with improved electrical strength, i.e. dielectric strength, i.e. electrical resistance and improved dielectric properties, i.e. impedance and/or permittivity; the invention further concerns a method for its manufacture and cables, transformers, capacitors, and/or other items of electrical equipment that are equipped with this insulation material.

The papers with a proportion of hydrophobic fillers, such as, for example, mica or talcum, have, in comparison to unfilled papers of the same kind, an increased dielectric strength with a lower electrical loss factor (tan δ).

Cellulose-based papers have long been established as an electrical insulation material for applications in the field of high-voltage engineering. The grammage of such papers is usually in the range of 70-120 g/m² and the density is between 0.6 to 1.2 g/m², wherein the high densities are normally the result of densification between pressure-loaded rolls (a calendering process). As an inexpensive material with a high level of flexibility and very good mechanical and electrical properties, paper continues to play an important role in the field of electrical insulation. Applications extend to all types of transformers, cables and capacitors, in particular to oil-filled transformers, cables and capacitors.

The fast growth of electrical power consumption in recent years has created a requirement for increased power transmission capacity by means of higher operating voltages. When the transmission voltages increase, the electrical breakdown strength and the dielectric losses become more and more a limiting factor. Consequently, there exists an increasing necessity to find materials that are as inexpensive as possible, which increase the dielectric strength and reduce the dielectric loss factor of the insulation material. Here the high electrical breakdown strength that is sought is required to withstand high electrical potential gradients, and thus to allow the required radial dimensions for the application in question.

The dielectric loss factor (tan δ) is an important parameter in the assessment of an insulating medium. The level of the loss factor is a function of the temperature, electrical frequency and voltage, and is important when a dielectric is used in alternating electrical fields. The dielectric loss factor (tan δ) is defined as the ratio of active power to reactive power, and is thus a measure for the level of energy that is absorbed within an insulation material in an alternating electrical field and converted into heat loss. It is therefore desirable to keep tan δ as low as possible.

In addition to the cited electrical properties the material that is sought must have a certain minimum mechanical strength in the interests of processing, and for purposes of impregnation with an electrically insulating impregnation agent, for example oil, must have as high a permeability as possible so as to allow rapid penetration by the impregnation agent used for the insulation. It must also preferably be the case that the papers used for cable insulation have mechanical properties that enable them to be wound around the conductor in a technically practical manner.

In accordance with the prior art such papers that are cellulose-based are always unfilled and are preferably manufactured from a pure kraft pulp. Here, for purposes of extending the service life of the paper, alkaline compounds can be incorporated as a buffer for purposes of absorbing any acid that may be generated. Furthermore, resins or synthetic fibres can be included for purposes of increasing the mechanical strength parameters.

In order for the electrical insulation to be able to withstand higher electrical potential gradients, one possible solution could also be to use very thin papers, since by the reduction of their thickness whilst other properties remain constant the breakdown strength, i.e. the dielectric strength, is increased. However, in this regard the mechanical properties relating to the strength of the insulation paper would be impaired, which in turn would impair the industrial viability of the winding process, so that on its own this does not represent a practical solution.

DE 4314620A1 and EP0623936 describe a temperature-resistant electrical insulation paper that can be manufactured simply and cost-effectively, and which is based on plastic resin fibres and polymer fibrils that act as a binding agent for the fibres. Insulation materials that have been used up to the present time are, for example, resin-impregnated glass mats and glass fabrics, laminar structures of special blends of pulp, films of polyester or polyamide, as well as products similar to paper made from aromatic polyamides. While these insulation materials as a rule exhibit good electrical properties, and usually good mechanical properties also, their manufacture is more cost-intensive, so that the electrical machinery becomes considerably more expensive. Some of these papers are very brittle and break, in particular when subjected to buckling loads. Papers made from aromatic polyamides show especially good temperature resistance, but their mechanical properties, in particular their high degree of elastic recovery from deformation, are detrimental during processing. The resistance to continuing smouldering also leaves something to be desired. The object underlying DE 4314620A1 and EP0623936 was therefore the provision of electrical insulation materials that have good mechanical and electrical properties, and are resistant to temperature. However, these materials are comparatively expensive and are not based on renewable raw materials.

In the prior art this object is achieved by the use of 15 to 95% by weight of plastic resin fibres in the presence of polymer fibrils, plastic resin powder and mineral fillers. In particular, however, pulps or other renewable fibrous raw materials are not used, in contrast to the inventive method and the products that are manufactured with the latter.

The object of the present invention is to overcome, at least partly, the known disadvantages in the prior art, and in particular to provide a paper that can be manufactured inexpensively and at the same time has a high dielectric strength and also a low dielectric loss factor and a good permeability for oil. In contrast to electrical insulation papers made from plastic resin fibres, the said papers that are to be used are predominantly made from renewable raw materials without the use of petroleum-based fibre materials, and the method and the products have an increased cost-effectiveness compared with the prior art.

This object of the invention is achieved by means of an electrical insulation paper in accordance with Claim 1. Preferred configurations of the electrical insulation paper are the subject of the dependent claims. The object is also achieved by means of a method for the manufacture of the electrical insulation paper and its use.

The inventive electrical insulation paper has an electrical breakdown strength of more than 40 kV/mm, preferably more than 60 kV/mm, and in particular more than 80 kV/mm, wherein this is achieved in that the inventive paper has 20 to 99% by weight of cellulose, and 1 to 80% by weight of mineral fillers, wherein the mineral filler has at least one layered silicate, which preferably contains talcum and/or mica.

In accordance with a particularly preferred form of embodiment the proportion of cellulose lies in a range between 30 to 80% by weight, preferably 45 to 70% by weight, and in particular approx. 65% by weight. Furthermore the proportion of mineral fillers preferably lies in a range between 3 to 65% by weight, preferably 5 to 45% by weight, and in particular approx. 30% by weight.

The proportion of talcum in the mineral filler of the inventive electrical insulation paper preferably lies between 1 and 100%, preferably between 25 and 75%, in particular between 35% and 60%, and particularly preferably above 50%. Talcum is a hydrophobic mineral, which has many applications by virtue of its chemical and thermal stability and its lamellar morphology. Talcum can be considered to be a kind of inorganic polymer, which is constructed from two “monomer” structures, namely tetrahedral silicate layers, and octahedral network layers (a type of brucite). Externally this is covered on both sides by a continuous silicate layer. Talcum can contain various quantities of socially acceptable minerals; these are predominantly chlorite (water-containing aluminium and magnesium silicates), magnesite (magnesium carbonate), calcite (calcium carbonate) and dolomite (calcium and magnesium carbonate). By virtue of its low loss factor, the good dielectric properties, the high thermal conductivity and low electrical conductivity, as well as the comparatively high level of oil retention, and at the same time a low propensity for water retention combined with relative chemical inertness, talcum is particularly well suited to be an inventive filler.

In addition to talcum the mineral filler can also have mica as a component, the proportion of which is preferably between 1% and 80%, in particular between 10 and 50%, and particularly preferably is more than 20%. It is also within the context of the present invention to use mica exclusively as the mineral filler. Mica is a clear, transparent material (aluminium silicate) with a high electrical resistance. It is resistant to a constant operating temperature of 550° C. and has a melting point of approx. 1250° C. Furthermore mica is resistant to almost all media such as e.g. alkalis, chemical products, gases, oils and acids. Mica is made up from a group of minerals of monoclinic, i.e. pseudo-hexagonal complex silicates, which are distinguished in terms of having a perfect basal cleavage capability.

They can be split very easily into thin, flexible and elastic leaves. In accordance with the present invention mica is understood to include true mica, brittle mica, and mica with a lack of intermediate layer cations. Muscovite-mica and phlogopite-mica are also of particular importance.

The mineral fillers, in particular also the layered silicates that are to be used, preferably have an average particle size distribution of 0.5 to 400 μm, and in particular of 1 to 200 μm, and/or leaves with an average thickness of 0.01 to 100 μm, and in particular of 0.1 to 50 μm.

With a high filler content the addition of fillers can cause a reduction of the mechanical strength parameters of the paper as a result of lower fibre-fibre interactions. In order to counter this effect it is possible to add natural or modified starch in proportions of 0.1-10% by weight, in particular 2 to 8% by weight, and particularly preferably approx. 4% by weight, or also other polyoses, such as, for example, natural or modified guar. On occasion such polyoses can also be used in combination with one another.

In accordance with a preferred form of embodiment the proportion of modified or unmodified guar can lie between 0.1 and 5% by weight, in particular between 2 and 4% by weight, and in particular approx. 2.5% by weight. Furthermore organic binders can be used, either in combination or on their own, the proportion of which can lie between 0.1 and 20% by weight, in particular between 3 and 12% by weight, and preferably at approx. 5 to 8% by weight. In a further preferred form of embodiment a wet strength agent can be added to the inventive electrical insulation paper as a further additive, either in combination or on its own, in a proportion of between 0.1 and 20% by weight, in particular 1 to 14% by weight, and in particular approx. 5 to 8% by weight. The addition of a hydrophobising agent, either in combination or on its own, in the range of 0.01 to 5% by weight, in particular 0.1 to 3% by weight, and preferably approx. 0.5% also lies within the context of the present invention. Furthermore a nitrogenous alkaline compound can be added to the inventive electrical insulation paper, either in combination or on its own, in a proportion of between 0.01 and 5% by weight, in particular 0.1 to 3% by weight, and in particular approx. 0.5% by weight.

A further improvement can be offered by the addition of polymers with binding or co-binding capabilities, such as, for example, the addition of 0.1 to 10% by weight, in particular 1 to 6% by weight, of polyvinyl alcohol (PVA).

The inventively manufactured paper has excellent mechanical strength and can be exposed to the high voltages occurring in high-voltage equipment. Here the loss factor in the insulation paper is evenly reduced at all points and the paper can be manufactured, in a trouble-free manner and on an economical scale, even more inexpensively than comparable papers without fillers, since expensive pulp fibres are replaced by less expensive naturally occurring fillers. Thus the dielectric strength of the inventive electrical insulation paper, measured in accordance with DIN 53481, is more than 40 kV/mm, preferably more than 60 kV/mm, and in particular more than 80 kV/mm, and/or the conductivity in the hot water extract, measured in accordance with TAPPI Standard T 252, is less than 5 mS/m, preferably less than 3 mS/m, and in particular less than 1 mS/m. Also the conductivity 53481 of the inventive electrical insulation paper in the hot water extract in accordance with TAPPI standard T 252 is preferably less than 5 mS/m, in particular 3 mS/m, and in particular less than 1 mS/m.

All pulps and polysaccharides that are in use today can be used as the initial material. Here, by virtue of the higher comparable mechanical strength and electrical breakdown strength, kraft pulps are preferred. Here the degree of fibrillation should on the one hand be as high as possible for reasons of the insulation effect, that is to say the fibrous material should be present in a finely ground state with a Schopper-Riegler value of preferably 40 to 80° SR. On the other hand a finely ground pulp forms a more dense paper with a lesser rate of penetration of the oil that is required for the insulation, so that the rate of penetration of the oil into the paper is too slow for purposes of practical economic production. For this reason the person skilled in the art will adjust the level of grinding of the pulp, taking into account the above points, and if possible will settle in a range of 20 to 60° SR, preferably of 25 to 40° SR.

The pulps that are used can, if required, also be replaced with other plastic fibres, either in order to increase the mechanical strength parameters of the end product, or to characterise the end product for reasons of marketing or product safety.

Finely ground solids can be used as fillers, which are insoluble in the course of the manufacturing process. Here layered silicates such as, for example, mica or talcum, are preferred, with hydrophobic properties that are as high as possible, measured, for example, in terms of the contact angle with respect to water. With increasing hydrophobic properties the storage of water in the finished paper is made more difficult, and as a result the drying of the paper down to a very low water content, preferably of less than 1%, is made easier. With a higher water content in the finished insulation paper the dielectric strength is impaired and the ageing processes when the isolation paper is in use are accelerated.

Layered silicates, in particular silicates with two or three layers, are in particular mineral materials such as mica, talcum, serpentine and clay minerals such as vermiculite, muscovite (a three-layer silicate) (KAl₂[(OH)₂IAISi₃O₁₀]), kaolinite (a two-layer silicate) (Al₄[(OH)₈lSi₄O₁₀]), phlogopite, or artificial layered silicates such as, for example Na₂Si₂O₅.

The starch that is added can be used in the chemically unmodified form as gelatinised or ungelatinised starch. However, chemically modified starches, hydrolytic or oxidative or enzymatic starches, or starches degraded by physical effects, can also find application here. The starches can also be present in a hydrophobically or ionically modified form. In the case of ionically modified starches low levels of substitution are preferred, since the result can otherwise be a deterioration of the dielectric loss factor.

Other hemicelluloses or polyoses, such as, for example, natural or modified guar, can be added to the starch for purposes of increasing strength, or can on occasion completely replace the latter. These can also be present in a hydrophobically or ionically modified form, and here too a low average level of substitution is preferred, in an analogous manner to the starch.

A further improvement of the electrical insulation properties can take place with the addition of polymers with binding or co-binding capabilities. In addition to the organic polymeric binder systems and/or latices of known art in the manufacture and/or finishing of paper, the addition of 0.1 to 5% by weight, (with reference to the finish-dried end product) of polyvinyl alcohol (PVA) is preferred. Here the polyvinyl alcohols can be present both in a fully hydrolysed form, and also in a partially hydrolysed form, with different levels of polymerisation and chain lengths, branched or unbranched, as homo-polymers or copolymers. The dissolution behaviour of polyvinyl alcohols is known to be dependent to a large extent both on their structure and the degree of branching, on the molecular weight, and also on the degree of hydrolysis. Of particular importance here are the dissolution temperature, the stirring speed and duration, as well as the geometric embodiment of the stirring vessel, the stirrer, and any flow resistances that may be present. The person skilled in the art will adapt his procedure to the particular product in question.

In order to increase the hydrophobic properties of the inventive electrical insulation paper and thus to increase the wetting rate with the insulation oil, a sizing agent can be added to the paper during manufacture, or also, if necessary, in a separate step. For this purpose the products already of known art in this respect, such as alkylketene dimers (AKDs) of differing chain lengths, are particularly suitable. However, alkenyl succinic acid anhydrides (ASA) and also, for example, paraffins can also find application for this purpose.

Increases in the strength of the electrical insulation paper can also be achieved by the addition of wet strength agents such as, for example, melamine- or urea-formaldehyde resins, amidoamine- or polyamide-epichlorhydrin resins, or also wet strength agents based on hemiacetal- and acetal compounds, such as glyoxals.

In order to improve the long-term stability of the inventive paper alkaline compounds, in particular nitrogenous alkaline compounds can also be added to the paper as a buffer, and for purposes of binding any acidic degradation products that may be generated. Here nitrogenous compounds such as, for example, dicyanamides, compounds containing melamine, compounds containing urea, or also polymers or polyamides containing amino groups, are preferred.

In order to obtain high electrical gradients a possible solution could lie in utilisation of the property in accordance with which the electrical breakdown strength of paper alters in proportion to its porosity. However, in its practical application this solution also has its limits, since the paper in the course of processing must in general be fully penetrated by the insulation oil. In addition to the question of the loss factor a paper with a considerably higher impermeability may not be completely impregnated, if in the application it is wound on in a compact manner and, if necessary, a multiple number of times. The inventive products have in comparison to unfilled insulation papers a significantly higher porosity and a significantly increased rate of penetration with respect to oleophilic fluids.

Insulation paper is divided into a large number of types and qualities, including coil insulation paper, silk capacitor paper, high-voltage capacitor paper, cable insulation paper, extremely high voltage cable insulation paper, and similar. Papers of all these types can be treated in accordance with the invention in order to increase the dielectric strength and to reduce the loss factor and also the ageing processes.

The inventive electrical insulation papers are manufactured in accordance with the methods in common use in the paper industry. In a preferred form of embodiment the fibrous or powdered initial materials are formed into a slurry in water and a suspension is manufactured with a solid content of preferably 0.1 to 10% by weight. This process takes place in the methods for paper manufacture in common use with a pH in the range from 4 to 10, preferably with a pH of 7 to 9. This suspension thus obtained is applied onto conventional paper machines e.g. fourdrinier machines, or circular screening machines, or gap-former machines, where it is distributed over a planar area and the majority of the water is drained off and removed by means of compression and drying.

The paper fibres are held together by means of the fibrils, so that the raw paper created maintains a sufficient initial wet strength. If necessary the strength of the paper can be increased further by means of strength-enhancing additives such as natural or modified starch, natural or organic binders, and also polyvinyl alcohols. This raw paper is then dried at temperatures between 100 and 180° C., preferably between 80 and 180° C., e.g. by passing it over heated cylinders. At an elevated temperature it is then smoothed and densified under pressure as necessary. This can be undertaken on conventional smoothing rollers and/or rolling mills, wherein a relatively high pressure is exerted onto the paper. The temperatures during this smoothing or compressing process lie in accordance with the invention in a range above 80° C. or 100° C., preferably above 160° C. or 180° C. The paper can also be further strengthened by subsequent impregnation with resins, e.g. epoxy-, formaldehyde-, polyester-, silicon-, phenol-, or acrylate resins, or with polyimides, or, on occasion, by means of impregnation with varnishes on the basis of, for example, alkylphenols, imides or silicons. Composite materials can also be manufactured, by laminating the electrical insulation paper with films, e.g. with polyethylene-, polypropylene-, or polyimide films.

Should it be advantageous in terms of the product requirements the inventive paper can be further treated downstream of the manufacturing process with the aid of a densification and smoothing process (calendering). This can lead to a further improvement in the breakdown resistance.

The invention also comprises, in addition to the product and its methods of manufacture, the use of the inventive electrical insulation paper for the electrical insulation of components or products carrying electrical current, such as, for example, printed circuit boards, batteries and capacitors, cables, in particular cables with a coated and impregnated dielectric, in which, for example, the insulation is wound in an overlapping and/or helical manner, transformers, in particular dry or oil-filled types of transformers, combinations of these and similar.

In what follows the invention is described with the aid of various examples, wherein it should be noted that the present invention is not limited to these, but rather that modifications and additions, as obtained by the person skilled in the art from the present documentation, also determine the scope of the present invention.

Here:

Table 1 shows the influence of various pulp fibres and material compositions on the electrical breakdown strength and mechanical strength parameters;

Table 2 shows a comparison between papers of the prior art and the inventive electrical insulation papers;

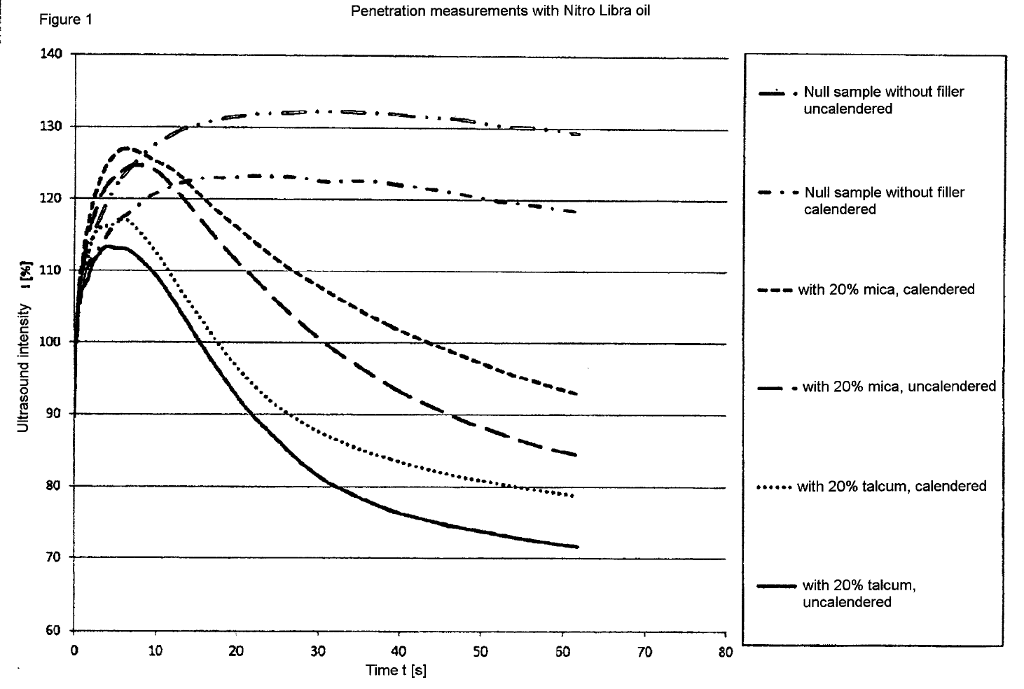

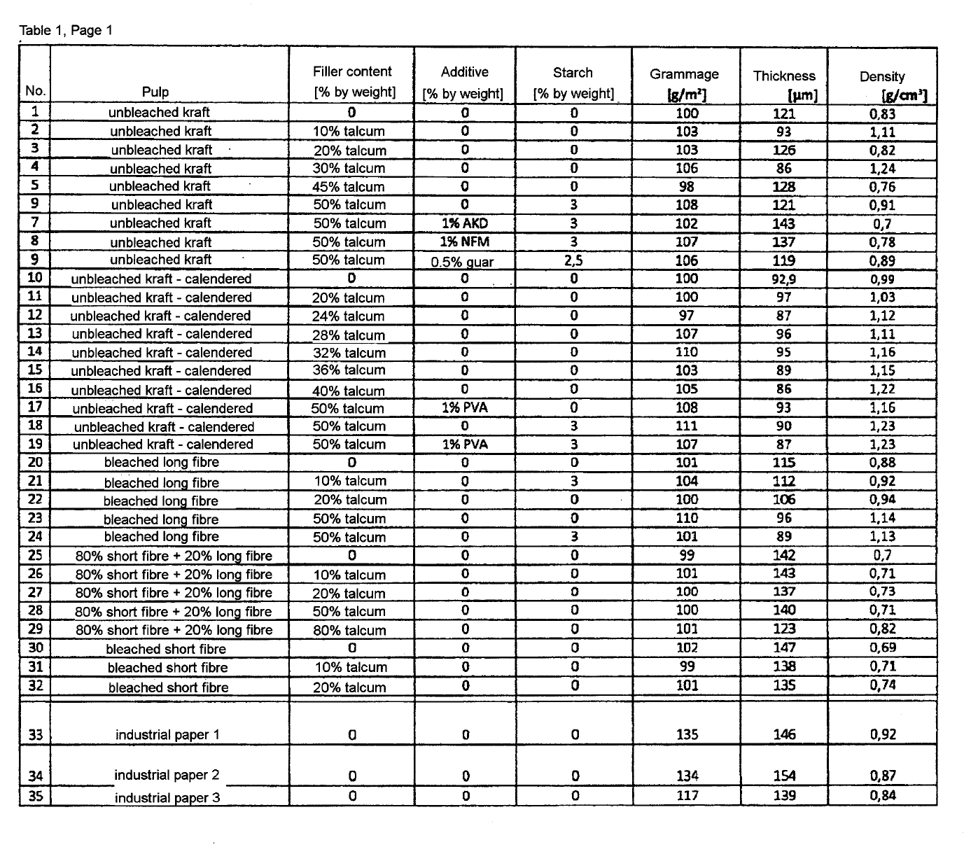

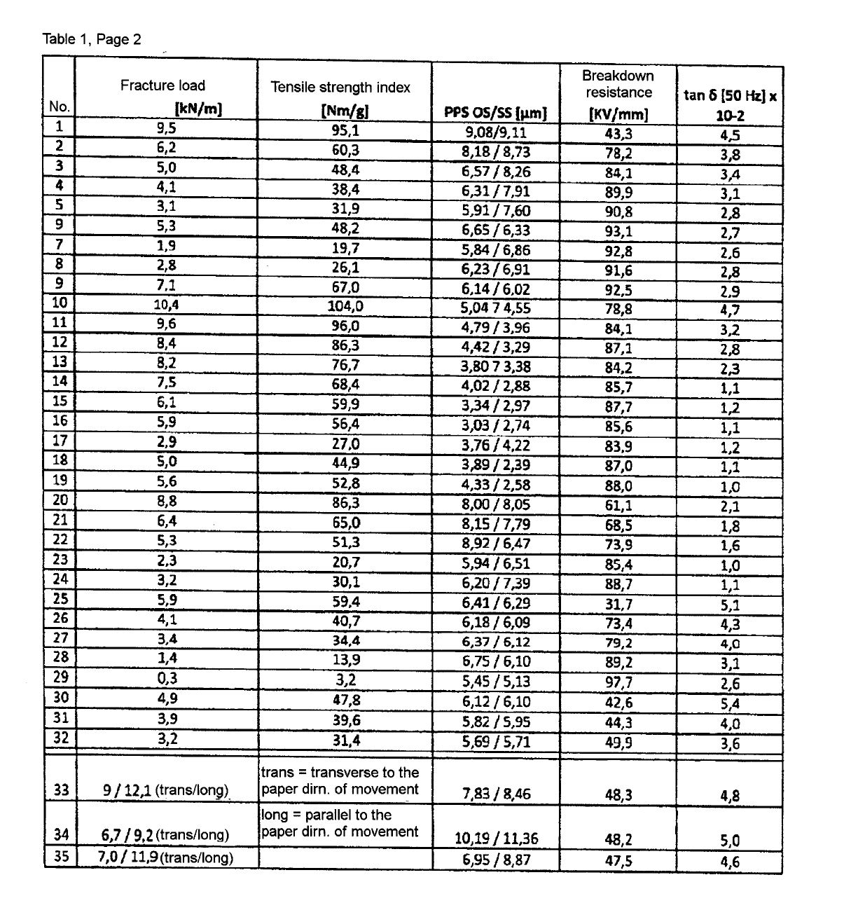

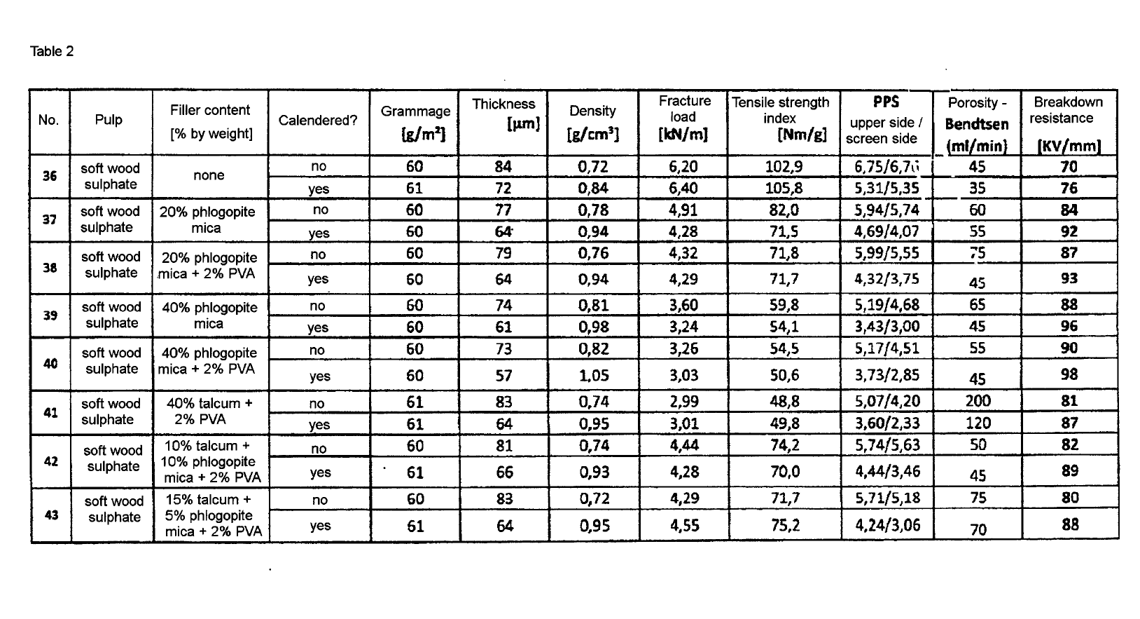

FIG. 1 shows a diagram of the oil retention profile for various papers as a function of time.

The determination of the dielectric strength is undertaken in accordance with DIN EN 60212 and DIN EN 60243-1. However, in a deviation from what is stated in DIN EN 60243-1, Section 4.1.2 steel ball electrodes of 6.3 mm diameter have been used for the dielectric test.

For testing for the properties as an electrical insulation paper the samples were completely impregnated for at least 30 minutes with a mineral oil (Nytro Libra) from the Nynas company, which is in common use for such purposes. The silicon oil XIAMETER PMX-200 from Dow Corning was used as an alternative. In the presence of the insulation oil the sample was then exposed to a field of increasing voltage and the strength of the maximum voltage before breakdown of the sample was determined automatically. The values thus obtained from a number of measurements were evaluated in accordance with relevant statistical methods, e.g. a Weibull analysis. The conversion to the electrical breakdown strength per millimetre is undertaken taking into account the thickness of the sample.

The tensile strength and fracture resistance were determined in accordance with EN ISO 1924-2.

Conductivity was determined on the basis of a hot water extract in accordance with the TAPPI Standard T 252.

The proportions and percentages in the examples are cited with reference to the weight. The pulp that was used was ground to a Schopper-Riegler value of 32 to 34° SR before use. Examples 1 to 32 in Table 1 relate to the evaluation of various papers relative to null samples, which were manufactured from the specified pulp with/without the addition of fillers and with/without the addition of additives. The said paper was carefully dried and acclimatised in a desiccator by means of a drying agent at a constant temperature of 25° C. AKD=alkylketene dimmer, in the form of a commercial dispersion, was used as a sizing agent. A polyamidoamine epichlorhydrin resin was used as a wet strength agent.

Examples 33 to 35 in Table 1 show results measured on commercially available electrical insulation papers.

For testing for the properties as an electrical insulation paper the test samples were completely impregnated for at least 30 minutes with a mineral oil (Nytro Libra from the Nynas company) that is in common use for such purposes. The silicon oil XIAMETER PMX-200 from Dow Corning was used as an alternative. Testing of the dielectric strength took place using standard apparatus in accordance with ASTM Standard D 149-87.

Measurement of the dielectric strength values always took place after acclimatisation of the sample, either in a standard atmosphere, in a desiccator filled with a drying agent, or at a high vacuum at temperatures of 60 to 80° C. and with an acclimatisation time of 6 to 48 hours. The subsequent oil penetration took place either at standard pressure or at a vacuum of up to 10⁴ bar.

Table 1 shows the influence of the pulp fibres and the fillers and/or additives used in each case on the electrical breakdown strength and mechanical strength. Here it can be seen that unbleached kraft pulp has the best properties.

The electrical insulation paper thus obtained has the properties reproduced in Table 1. Here OS denotes the upper side of the paper, and SS denotes the side facing towards the screen during paper manufacture. In the strength parameters of the industrially manufactured papers “trans” denotes the measurement transverse to the direction of movement of the paper machine, and “long” denotes the measurement in the longitudinal direction of the paper machine. In the case of the comparative papers, manufactured on a Rapid-Köthen laboratory sheet former, this information is absent, since here there is no preferred direction of movement, or fibre orientation.

From Table 1 it is clear to see that the inventive papers, compared with the prior art, are distinguished by a higher electrical breakdown resistance at a lower loss factor (tan δ). Furthermore the replacement of fibrous materials by fillers is seen to be an economical advantage. The roughness measured in accordance with the Parker Print-Surf instrument on the upper side and the screen side respectively is specified as PPS OS/SS in mm. The procedure for the manufacture of inventive products can, for example, but not exclusively, be undertaken in the following manner:
Preparation of a weighed quantity of e.g. unbleached kraft pulp that is as pure as possible, or a mixture of pulps (for example 360 g oven dried=ovdr).
Introduction of the pulp into laboratory compaction equipment and filling of the laboratory compaction equipment with pure water. With 15 litres and 360 g of pulp, for example, after compaction a material density of 2.4% ensues.
Compaction of the pulp for 15 minutes, for example, and subsequent testing of the level of grinding; if necessary further compaction until the desired level of grinding is attained.
Alternatively the pulp can also be fibrillated with any other suitable equipment, for example with a Hollander machine, or a refiner.
In order to obtain a pulp for electrical insulation purposes that is as pure as possible, the pulp can subsequently, for example, be further freed from contaminants and charge carriers with the aid of a centrifuge.

In Table 2 with examples 36 to 43 studies are presented relative to a comparative paper in accordance with prior art made from kraft pulp (no. 36). The comparative paper is compared with the inventive papers, which have been manufactured with modified material prescriptions, i.e. with/without the addition of the fillers (talcum and/or mica), and with/without the addition of additives. These papers were all carefully dried and acclimatised in a desiccator by means of a drying agent at a constant temperature of 25° C. From the breakdown values found in Table 2 it is clear to see that the addition of talcum or mica, or a mixture of talcum and mica, leads to an increase of the dielectric strength, to reduced surface roughness, and to an increased porosity by nearly a factor of 4.

FIG. 1 shows the oil retention profile for various papers as a function of time. Here papers without fillers are compared with papers with 20% mica and 20% talcum as fillers. In all cases approx. 40° SR was used. This figure shows the penetration rate measured as a function of time with an ultrasound-based measuring instrument (DPA tester). The faster the fall in the curve after reaching the maximum, the greater is the penetration rate of the fluid. The insulation paper filled with talcum shows the highest penetration rate with, at the same time, the highest level of porosity. In the FIG. 1 diagram it is clear to see that addition of the filler results directly in an accelerated penetration of the insulation oil into the paper. By virtue of the fact that penetration of the insulation oil can take a number of days in the manufacturing process for transformers, an acceleration of this step that determines the rate is a great advantage of the inventive papers.

1. An electrical insulation paper comprising:
a first proportion of 20-99% by weight of cellulose and a second proportion of 1-80% by weight of mineral fillers, wherein the mineral filler includes between 1% and 100% talcum, and the talcum has an average particle size distribution of 0.5 to 400 μm, and has an average thickness of 0.01 to 100 μm, such that the electrical insulation paper has a dielectric strength measured in accordance with DIN EN 60243-1 of more than 40 kV/mm, and a conductivity in a the hot water extract in accordance with TAPPI Standard T 252 of less than 5 mS/m.

2-17. (canceled)

18. The electrical insulation paper in accordance with claim 1, wherein the first proportion of cellulose is 30% to 80% by weight and the second proportion of mineral fillers is 3% to 65% by weight.

19. The electrical insulation paper in accordance with claim 1, wherein the talcum ranges between 25% and 75% for the mineral filler.

20. The electrical insulation paper in accordance with claim 1, wherein the mineral filler includes between 1% and 80% mica.

21. The electrical insulation paper in accordance with claim 1, further including 0.1% to 10% by weight of polyvinyl alcohols.

22. The electrical insulation paper in accordance with claim 1, further including 0.1% to 10% by weight of at least one of a modified starch and an unmodified starch.

23. The electrical insulation paper in accordance with claim 1, wherein the dielectric strength measured in accordance with DIN EN 60243-1 is more than 60 kV/mm.

24. The electrical insulation paper in accordance with claim 1, wherein the conductivity in the hot water extract in accordance with TAPPI standard T 252 is less than 3 mS/m.

25. The electrical insulation paper in accordance with claim 1, further including 0.1% to 5% by weight of at least one of a modified guar and an unmodified guar.

26. The electrical insulation paper in accordance with claim 1, further including 0.1% to 20% by weight of at least one of an organic polymer and a binder.

27. The electrical insulation paper in accordance with claim 1, further including 0.1% to 20% by weight of a wet strength agent.

28. The electrical insulation paper in accordance with claim 1, further including 0.01% to 5% by weight of a hydrophobizing agent.

29. The electrical insulation paper in accordance with claim 1, further including 0.01% to 5% by weight of a nitrogenous alkaline compound.

30. The electrical insulation paper in accordance with claim 1, wherein the mineral filler has an average particle size distribution of 1 to 200 μm, and has an average thickness of 0.1 to 50 μm.

31. A use of electrical insulation paper in accordance with claim 1, for the electrical insulation of components or products carrying electrical current, including printed circuit boards, batteries and capacitors, cables, transformers, and combinations thereof, wherein the use is undertaken at least one of dry and with an electrically insulating impregnation agent.

32. The use of electrical insulation paper in accordance with claim 31 for cables having a coated and impregnated dielectric, in which insulation is wound in at least one of an overlapping manner and a helical manner.

33. A method for the manufacture of an electrical insulation paper in accordance with claim 1, comprising:
manufacture of a suspension of fibrous material and filler with a fibrous material density of between 0.1% and 10%;
removal of water from the material suspension in a paper machine; and
drying of the material suspension, from which water has been mechanically removed, at a temperature of between 60° C. and 180° C.

34. The method for the manufacture of an electrical insulation paper in accordance with claim 33, wherein the material suspension from which water has been removed, and which has been dried, is compressed and/or smoothed at a temperature of more than 100° C.
